(19) United States
(12) Patent Application Publication
(10) Pub. No.: US 2025/0109975 A1
(43) Pub. Date: Apr. 3, 2025

(54) OBSTRUCTION COMPONENT FOR A PROCESS FLUID FLOW MEASUREMENT DEVICE

(71) Applicant: Rosemount Inc., Shakopee, MN (US)

(72) Inventor: Nathaniel Kirk Kenyon, Westminster, CO (US)

(21) Appl. No.: 18/476,924

(22) Filed: Sep. 28, 2023

(51) Int. Cl. G01F 1/36

(52) U.S. Cl. CPC G01F 1/36

(57) ABSTRACT

A fluid flow obstruction component for a process fluid flow measurement device is located in a fluid flow conduit and includes an upstream wall having a planar upstream surface and a downstream wall having a planar downstream surface that couples to the upstream surface along an apex. The apex includes a flat surface that extends from an upstream apex edge to a downstream apex edge. The upstream apex edge intersects with the upstream wall and the downstream apex edge intersects with the downstream wall.

### BACKGROUND

The present invention is related to industrial process control and measurement devices. More particularly, the invention is related to a device that measures fluid flow of a process fluid.

Field devices, such as process variable transmitters, are used by a number of industries to remotely sense or control a process variable. Such process variables are generally associated with fluids such as slurries, liquids, vapors, gasses, chemicals, pulp, petroleum, pharmaceuticals, food and other fluid processing plants. Process variables may include pressure, temperature, flow, turbidity, density, concentration, chemical compensation and other properties. Other examples of field devices include valves, actuators, heaters and controllers.

An industrial process fluid flow measurement device generally requires multiple components. For example, one type of process fluid flow transmitter includes a fluid obstruction device disposed in the fluid flow within a conduit. The process flow transmitter then measures a differential pressure before and after the fluid obstruction device, such as an orifice plate, v-cone, or conditioning orifice plate, in the fluid conduit and calculates the mass or volumetric flow of the fluid passing therethrough. The fluid obstruction device causes a differential pressure to be developed between the upstream and downstream sides of the obstruction, which is related to the flow rate of the fluid. The process variable fluid flow transmitter then conveys the fluid flow information to a process controller, which may be a computer located in a control room, or even another field device mounted in the field.

Wedge flow meters are generally used for measuring the flow of abrasive, viscous and erosive fluids. Wedge flow meters include two branched pressure ports that transmit high and low pressures on either side of a fluid obstruction device or element that has a wedge shape to restrict and generate a differential pressure (DP) signal in spool of pipe. Instrument branches transmit the differential pressure signal to a differential pressure transmitter generally through remote seals.

### SUMMARY

According to some aspects of this description, a fluid flow obstruction device for a process fluid flow measurement device located in a fluid flow conduit includes an upstream wall having a planar upstream surface, a downstream wall having a planar downstream surface that couples to the upstream surface along an apex. The apex includes a flat surface that extends from an upstream apex edge to a downstream apex edge. The upstream apex edge intersects with the upstream wall and the downstream apex edge intersects with the downstream wall.

According to some aspects of this description, a method of fabricating a fluid flow obstruction component located in a fluid flow conduit for a process fluid flow measurement device includes providing a wedge element having a planar upstream wall and a planar downstream wall that intersects with the upstream wall at first apex. Further, truncating the wedge element to remove the first apex and form a second apex. The second apex includes a flat surface that extends from an upstream apex edge to a downstream apex edge. The upstream apex edge intersects with the upstream wall and the downstream apex edge intersects with the downstream wall.

According to some aspects of this description, a system for measuring process fluid flow includes a fluid flow conduit having an inlet and an outlet, a fluid flow obstruction component and a differential pressure sensor disposed to sense differential process fluid pressure on either side of the fluid flow obstruction component. The fluid flow obstruction component includes an upstream wall having a planar upstream surface and a downstream wall having a planar downstream surface that couples to the upstream surface at an apex. The apex includes a flat surface that extends from an upstream apex edge to a downstream apex edge, the upstream apex edge intersecting with the upstream surface and the downstream apex edge intersecting with the downstream surface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates a schematic diagram of a process control system including a wedge flowmeter having a fluid flow conduit with an inlet and an outlet and a differential pressure transmitter;

FIG. 2 illustrates a cutaway view of a fluid flow conduit of the process control system of FIG. 1 with an internal wedge element as a fluid flow obstruction component;

FIG. 3 illustrates an embodiment of the differential pressure transmitter and control room of FIG. 1;

FIG. 4 illustrates a simplified block diagram of the differential pressure transmitter of FIG. 1;

FIG. 5 illustrates a schematic diagram of a fluid flow obstruction component or wedge element arranged and installed within a body of a fluid flow conduit;

FIG. 6 illustrates a schematic diagram of an embodiment of a fluid flow obstruction component or wedge element arranged and installed within a body of a fluid flow conduit;

FIG. 7 illustrates a schematic diagram of an embodiment of providing the fluid flow obstruction component or wedge element of FIG. 6;

FIG. 8 illustrates a cutaway view of an embodiment of a fluid flow conduit of a process control system that includes the wedge element of FIG. 7, a differential pressure transmitter and control room, such as the differential pressure transmitter and control room illustrated in FIG. 3;

FIG. 9 illustrates an exaggerated embodiment of a truncated flat apex and an exaggerated rounded apex having equivalently sized apex radii for purposes of comparison;

FIG. 10 is a graph illustrating an embodiment of flow test results for a six inch schedule 40 (Sch40) pipe wedge meter that has been flow tested with wedge elements having a rounded apex and equivalent truncated flat apex and being at a h/D ratio of 0.20;

FIG. 11 is a graph illustrating an embodiment of flow test results for a six inch schedule 40 (Sch40) pipe wedge meter that has been flow tested with wedge elements having a rounded apex and equivalent truncated flat apex and being at a h/D ratio of 0.60;

FIG. 12 illustrates an enlarged schematic view of an embodiment of a wear pattern on a truncated flat apex;

FIG. 13 illustrates an enlarged schematic view of a wear pattern on a rounded apex;

FIG. 14 is a graph illustrating an embodiment of flow test results for a two inch schedule 40 (Sch40) pipe wedge meter that has been flow tested with wedge elements having a rounded apex and equivalent truncated flat apex, and both being at a h/D ratio of 0.40;

FIG. 15 is a graph illustrating an embodiment of flow test results for a six inch schedule 40 (Sch40) pipe wedge meter that has been flow tested with wedge elements having a rounded apex and equivalent truncated flat apex, and both being at a h/D ratio of 0.60; and

FIG. 16 is an embodiment of a method of fabricating a fluid flow obstruction device.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Two of the most common wedge flow meter designs are an external wedge element and an internal wedge element. An external wedge element is generally made from angle-bar and welded into a V-shaped slot on the flow meter body. The advantage of an external wedge flow meter is that little specialized manufacturing equipment or tooling is required. The size of the external wedge element can be controlled by the size of the V-shaped slot and the size of the angle-bar used. A disadvantage of external wedge flow meters is the potentially reduced accuracy of the flow measurement due to the tolerances and weld deformation of the geometries involved. In addition, external wedges must be calibrated to obtain reasonable measurement accuracy.

An internal wedge element slides into the meter body and is anchored into position. The wedge element is generally manufactured with a cylindrical radius feature at the wedge element apex with the rounded outside wall of the wedge element having a radius of curvature slightly under sized from the wedge meter conduit body radius of curvature of the inner diameter to allow it to slide in. The rounded wedge shape of an internal wedge does not lend itself to traditional machining methods, i.e. milling, computer numerical control (CNC), etc., due to the difficulty in fixturing/holding the wedge element. Internal wedges are typically fabricated by first turning the outside diameter of a bar on a lathe to match the inner diameter of the wedge meter, then using wire electrical discharge machining (EDM) to cut the wedge shape from the bar stock. An advantage of internal wedges made this way is a higher accuracy than external wedges due to the improved manufacturing tolerances. Disadvantages of internal wedges are in its difficulties in fabricating, which may include material waste, a heavy and dense wedge element, specialized EDM process capabilities are required and large bar stock must be inventoried and processed resulting in material handling risks.

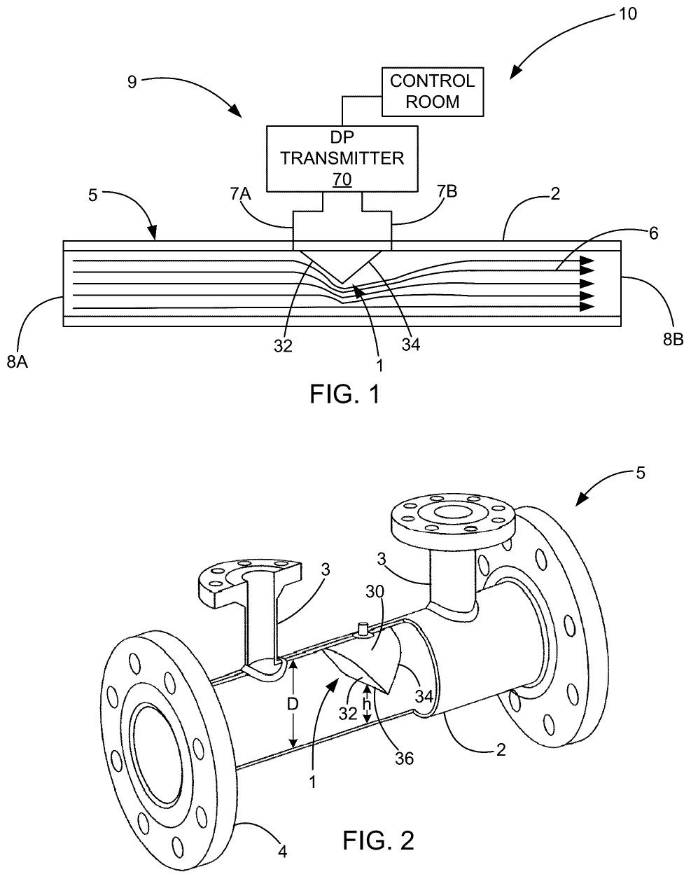

FIG. 1 illustrates a schematic diagram of a process control system 10 including a wedge flowmeter or pipe spool meter 9 having a fluid flow conduit 5, such as a pipe, with an inlet and an outlet and a differential pressure transmitter 70. A fluid flow obstruction device 1, embodied as a wedge element, is arranged and installed within a body 2 of fluid flow conduit 5. As illustrated in FIG. 1, fluid is shown to flow 6 in a direction from an inlet 8A to an outlet 8B of the fluid flow conduit 5. The constriction introduced by the fluid flow obstruction device 1 results in a differential pressure (DP) between each side of fluid flow obstruction device 1. The differential pressure (DP) is related to flow rate and is measured by differential pressure (DP) transmitter 70 and is translated to a flow rate measurement.

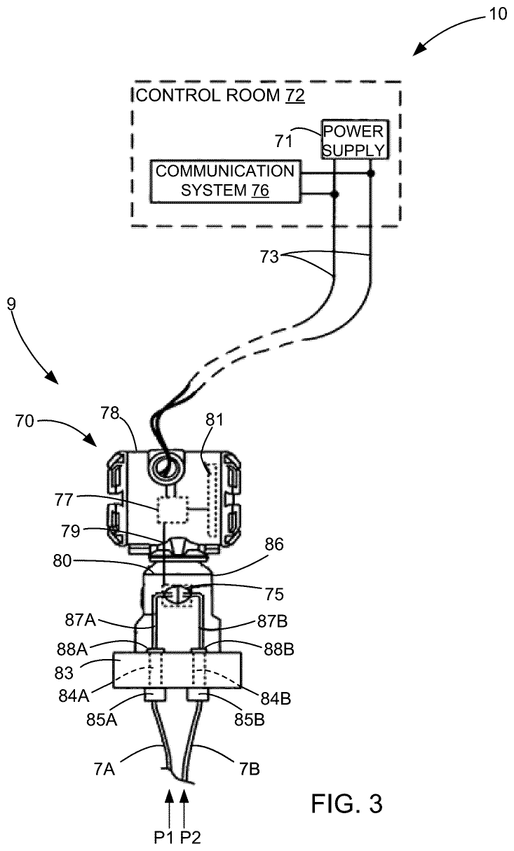

FIG. 2 illustrates a cutaway view of fluid flow conduit 5 of process control system 10 having an internal wedge element as fluid flow obstruction device 1. Two or more DP branches or flanges 3 split off the main run of pipe spool and are configured to transmit the differential pressure signal, i.e. high-pressure signal through connection 7A and low-pressure signal through connection 7B, to differential pressure transmitter 70. Sensor 75 (See FIG. 3) is disposed to sense the high-pressure signal, i.e. pressure P1 and the low-pressure signal, i.e. pressure P2, on either side of wedge element 1.

Wedge element 1 has a round outside wall 30 having a radius of curvature or diameter that corresponds the spool inner radius of curvature or inner diameter of conduit 5 and an upstream wall 32 and downstream wall 34 that makes a ninety degree angle with each other at a wedge element apex 36. A ratio of throat opening height h under the wedge element or wedge opening to the meter spool diameter D is called the h/D ratio. The size of wedge element 1, shaped as an internal wedge element, creates different h/D ratios within fluid flow conduit 5, resulting in different differential pressure signals for a given flow rate. Most wedge-style flow meter manufacturers offer h/D ratios in increments of 0.05 or 0.10 between 0.20 and 0.60 to satisfy most variation needs while containing the iterations to a finite value. Each flow application is looked at on a case-by-case basis to size the best wedge element. Factors that may be considered when determining a wedge element correspond to a given differential pressure within a given interior fluid flow conduit 5, or pipe, diameter D may include: minimum, normal and maximum Reynold's numbers, permanent pressure loss, accuracy of flow rate measurement, target differential pressure value at normal/maximum flow rates and transmitter differential pressure range. Fluid flowing past wedge element 1 in a wedge flow meter undergoes a pressure change as it speeds up through the pipe constriction caused by the wedge element. Sensing this pressure change with a DP transmitter through DP pressure branches 3 can result in a flow measurement with an appropriate flow computer.

FIG. 3 illustrates an example embodiment of process control system 10 which includes differential pressure (DP) transmitter 70 and a control room 72. Differential pressure transmitter 70 includes a sensor 75 that senses the pressure difference between pressure P1 and pressure P2 in a process fluid and then relays an electronic signal to control room 72 over control loop 73. In this example, control room 72 also supplies power to differential pressure transmitter 70 from power supply 71 over control loop 73. Control loop 73 also enables communication system 76 to communicate between control room 72 and differential pressure transmitter 70. In various embodiments, control loop 73 is a two-wire communication circuit, such as a 4-20 mA current loop or process control industry standard HART® or Fieldbus loop. In other embodiments, differential pressure transmitter 70 and control room 72 communicate over a wireless network such as WirelessHART®. In still other embodiments, output of differential pressure transmitter 70 is readable by a handheld device linked by wires or wirelessly with differential pressure transmitter 70.

Differential pressure transmitter 70 includes transmitter circuitry 77, sensor 75 and electronics housing 78. Transmitter circuitry 77 is electronically connected through wiring 79 to electronics board 80 for communication with control loop 73. Transmitter circuitry 77 includes components for transmitting electrical pressure signals generated by pressure sensor 75 over control loop 73 to control room 72 or to a local display such as LCD screen 81, or both. Transmitter circuitry 77 conditions the output of sensor 75 into a format compatible with control loop 73.

Sensor 75 is connected to the process fluid through connections 7A and 7B. Process flange 83 includes channels 84A and 84B, and connectors 85A and 85B. Sensor module 86 includes isolation tubes 87A and 87B and isolation diaphragm 88A and 88B. Isolation tubes 87A and 87B comprise passageways that are coupled with sensor 75 at their first ends and isolation diaphragms 88A and 88B at their second ends. Isolation diaphragms 88A and 88B are connected with process flange 83, which is typically bolted or secured to base of sensor module 86.

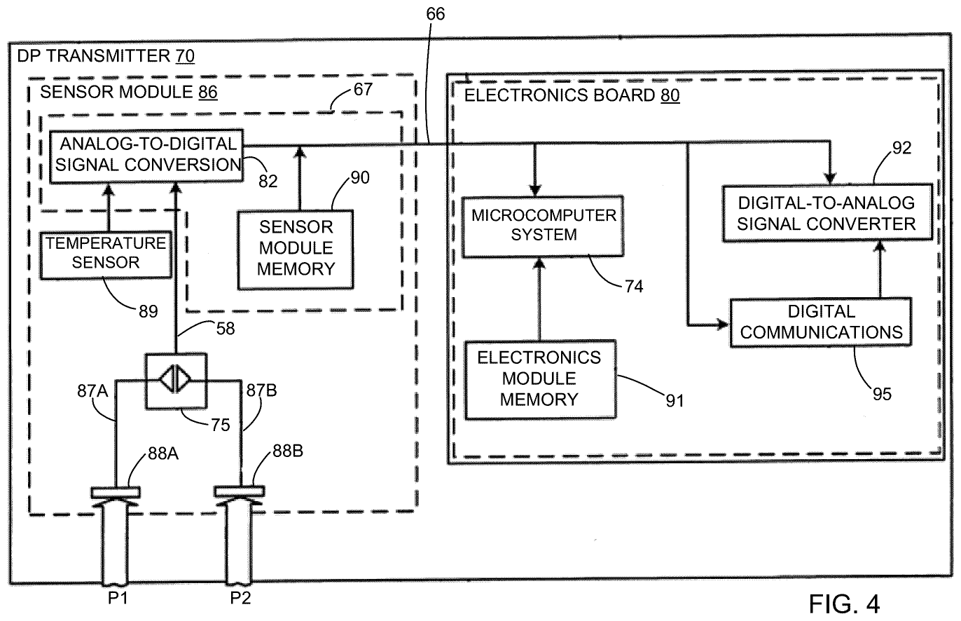

FIG. 4 is a simplified block diagram illustrative of DP transmitter 70. DP transmitter 70 includes sensor module 86 and electronics board 80 coupled together through a data bus 66. Sensor module 86 includes sensor module electronics 67 and sensor 75 which receives pressures P1 and P2 of the process fluid and provides an output 58 related to the differential pressure to an analog to digital converter 82. An optional temperature sensor 89 can be used for temperature compensation is also illustrated along with sensor module memory 90. Electronics board 80 includes a microcomputer system or microprocessor 74, electronics module memory 91, digital to analog signal convertor 92 and digital communication block 95.

Also illustrated in FIG. 4 are capillary or “fill” tubes 87A and 87B which are used to couple the sensor 75 to the process fluid. Isolation diaphragms 88A and 88B receive pressures P1 and P2, respectively, from the process fluid which is responsively applied to a fill fluid carried in capillary tubes 87A and 87B. Through this fluid fill, the pressures of the process fluid are applied to the sensor 75.

Wedge flow meters are used in applications that may damage or destroy other types of flow meters such as with erosive, viscous, clogging and abrasive fluids. Exemplary fluids may quickly wear out flow element geometries such as orifice plate or vortex shedders, wear through non-metal or thin pipe walls, clog impulse tubes, small passageways or moving parts and not be appropriate for magnetic Coriolis or ultrasonic flow meters. Exemplary troublesome fluids include sand or rock entrained fluid, asphalt, bottoms, slurries, paraffins. The flow path of troublesome fluids entering an orifice plate applies high friction via flow acceleration and a velocity vector change on the sensitive, sharp square edges of the orifice plate. Entrapped solids, sand, rocks or bubble can then wear out the edge of the orifice plate rapidly.

Wedge flow meters work for these difficult applications because the geometric design of the wedge element does not wear out in a way that impacts flow measurement nearly as quickly as competing technologies or primary elements. It also has widely spaced differential pressure branches or taps that easily incorporate remote seals to inhibit impulse tube clogging. The wedge meter is less sensitive to wear than an orifice plate because flow has less of an abrupt path around the wedge element obstruction due to the gradual angle or ramping of the upstream and downstream faces.

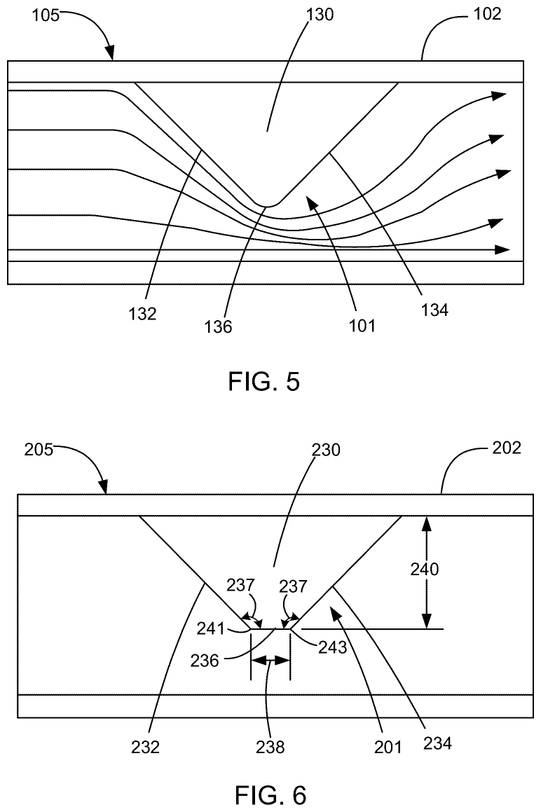

FIG. 5 illustrates a schematic diagram of a fluid flow obstruction component or wedge element 101 arranged and installed within a body 102 of a fluid flow conduit 105. Wedge element 101 in FIG. 5 illustrates an additional reason as to why the wedge meter is less sensitive to wear. While wedge element 101 has a round outside wall 130 having a radius of curvature that matches the spool inner diameter or radius of curvature of conduit 105 and an upstream face 132 and downstream face 134 that makes a ninety degree angle with each other, a wedge element apex 136 is rounded instead of having a sharp or square edge like apex 36 in FIGS. 1 and 2. Much like river rock in a stream or an already dull knife, the rounded apex 136 having an apex radius wears out more slowly than a sharper edge. The flow response over time and in difficult applications are more consistent and accurate with a wedge meter than other geometries of other types of flow meters.

However and as discussed above, wedge elements are already difficult to manufacture due to their shape and precision requirements. Creating a rounded apex 136, as illustrated in FIG. 5, can be further time consuming and machine-intensive, requiring several passes and interpolation on a CNC machine. Rounded apex 136 is also difficult to make consistently and tangentially to both the upstream and downstream faces of the wedge element. An electronic discharge machine (EDM) can fabricate the rounded apex radius feature with less effort than traditional mills or CNCs but EDMs are expensive, large and inefficient.

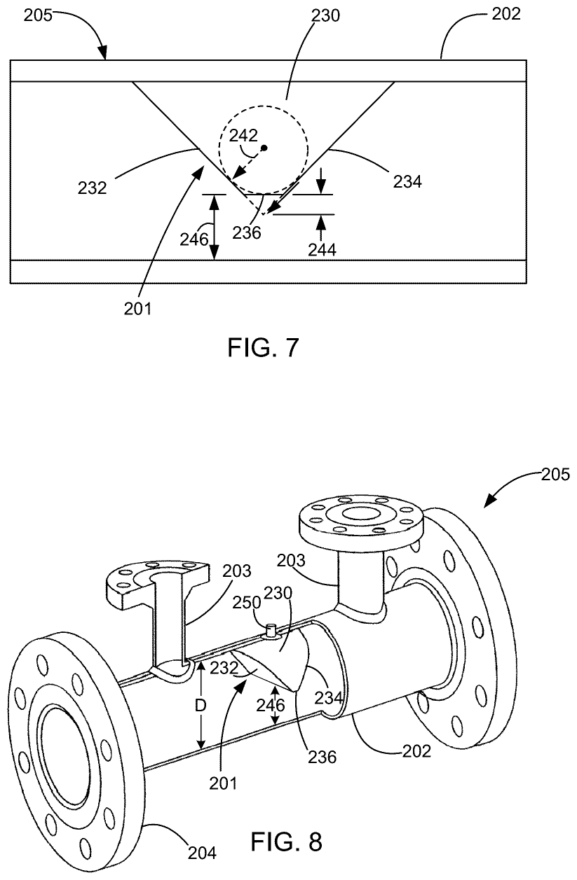

FIG. 6 illustrates a schematic diagram of an embodiment of a fluid flow obstruction component or wedge element 201 arranged and installed within a body 202 of a fluid flow conduit 205. Wedge element 201 has a round outside wall 230 (see also FIG. 8) with a radius of curvature that matches the radius of curvature of the inner diameter of conduit 205. Wedge element 201 includes an upstream wall 232 having a planar upstream surface and a downstream wall 234 having a planar downstream surface that couples to the upstream surface along an apex 236. Upstream wall 232 and therefore planar upstream surface are oriented at a perpendicular angle to downstream wall 234 and therefore planar downstream surface. Apex 236 has a truncated flat surface rather than having the rounded surface of apex 136 (FIG. 5) or having a sharp or square edge apex 36 (FIGS. 1 and 2).Truncated flat apex 236 extends between an upstream apex edge 241 and a downstream apex edge 243. Upstream apex edge 241 intersects with upstream wall 232 and downstream apex edge 243 intersects with downstream wall 234. This flat, straight apex 236 has an approximate uniform thickness or width 238 across the entirety of the apex of wedge element or component 201. For example, the flat width or land thickness 238 of wedge element 201 is between 0.001 and 0.034 inch to correspond to equivalent radii allowed by international wedge meter governing standards, such as ISO 5167-6. Such a flat width or land thickness 238 matches a truncation height 244 (FIG. 7) of 0.001 to 0.017 inch. The upper value of truncation height 244 of 0.017 inch corresponds to an equivalent apex radius 242 of 0.020 inch, which results in the most differential pressure generated and the least difference between truncated flat apex 236 and round apex 136 discharge coefficient (C), which will be discussed in detail below.

FIG. 7 illustrates a schematic diagram of a fluid flow obstruction component or wedge element 201. FIG. 8 illustrates a cutaway view of an embodiment of fluid flow conduit 205 of a process control system that includes wedge element 201. As illustrated in FIGS. 7, an apex radius 242 is used to determine the overall size of wedge element 201 or in other words, how far upstream face 232 is from downstream face 234. As indicated by 244, a truncation of wedge element 201 is created below or approximately at the outer circumference of apex radius 242 to form the truncated flat feature, which is a small uniform, flat surface apex 236 on wedge element 201 having a land thickness 238 (FIG. 6).

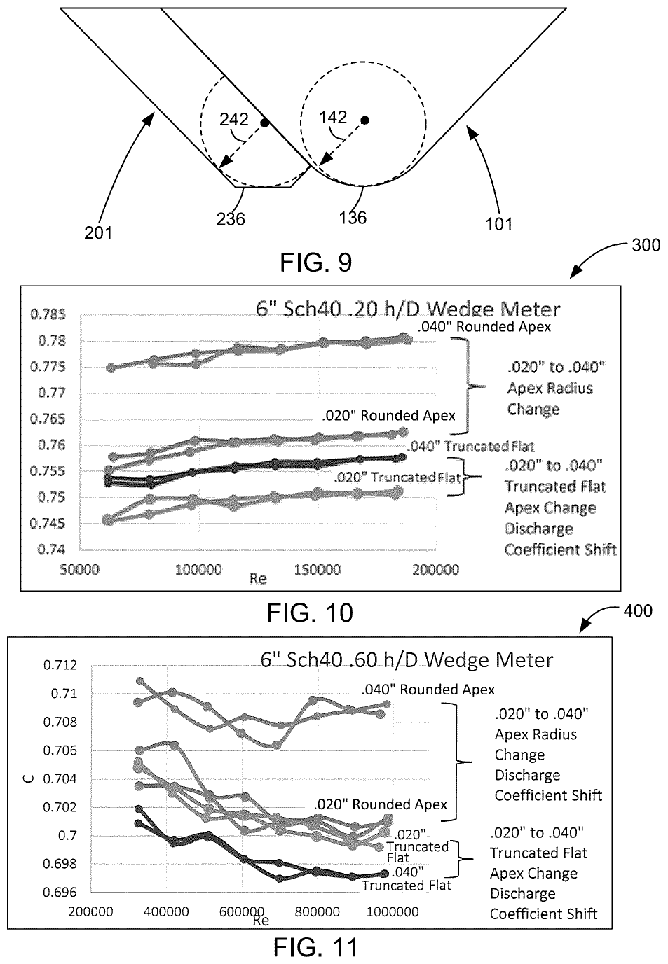

Wedge element 201 has similar upstream and downstream faces 232 and 234 as wedge element 101 but the apex is truncated to be flat instead of rounded. This is readily illustrated by the comparison of wedge element 101 and wedge element 201 in the exaggerated illustration of truncated flat apex 236 of wedge element 201 and rounded apex 136 of wedge element 101 in FIG. 9 where both wedge element 101 and wedge element 201 have equivalently sized apex radii 142 and 242. Still further and as illustrated in FIG. 8, wedge element 201 is anchored to the interior surface of conduit 205 by an anchor 250. This provides the truncated flat feature of wedge element 201 to have a wedge opening height (h) 246 that is comparably sized to a wedge opening height of rounded apex 136.

The truncated flat feature of apex 236 is easier to fabricate by traditional machining methods than a rounded radius feature of apex 136, has more consistent fabrication outcomes from component-to-component and has more predictable flow calibration results from meter-to-meter. The setup needs less reference datums, the tooling is more straightforward, there are less passes required, there is less programming required and most important it is easier to manufacture the truncated flat feature of apex 236 consistently, both in regards to feature width or land thickness 238 and wedge element height 240. These two factors are critical for reducing discharge coefficient variation from wedge meter-to-meter and thus being capable of providing an uncalibrated product.

Another advantage of truncated flat apex 236 is that variations in the feature size have less of a flow performance impact than equivalent variations to rounded apex 136. This is important under repeatable manufacturing. The truncated flat apex 236 is valuable even to manufacturers who can exceed the limitation of traditional machining by using an EDM due to the improvement in predictable flow performance.

In general, wedge meters have never been available with less than a 4-8% uncertainty unless the meters are calibrated. The truncated flat apex 236 makes it possible to have an uncalibrated wedge meter, which is possible by carefully controlling and tracking several factors that influence and characterize the expected discharge coefficient of a given iteration of a meter. Calibrating a meter adds cost. Truncated flat apex 236 reduces variation in flow response from unit-to-unit compared to rounded apex 136 and allows the ability to make an uncalibrated meter.

FIG. 10 is a graph 300 illustrating flow test results for a six inch schedule 40 (Sch40) pipe wedge meter that has been flow tested with wedge elements having a rounded apex 136 and equivalent truncated flat apex 236, both having apex radii or equivalent apex radii with a truncated apex of 0.020 inch and 0.040 inch and being at a h/D ratio of 0.20. FIG. 11 is a graph 400 illustrating flow test results for a six inch schedule 40 (Sch40) pipe wedge meter that has been flow tested with wedge elements having a rounded apex 136 and equivalent truncated flat apex 236, both having apex radii or equivalent apex radii with a truncated apex of 0.020 inch and 0.040 inch and being at a h/D ratio of 0.60. As illustrated in the graphs in FIGS. 10 and 11, some conclusions may be drawn. Truncated flat apexes and rounded apexes do not show sizable differences between each other regarding standard deviation of calibration (variance) or linearity of calibration. In other words, a truncated flat apex is just as valid as a rounded apex from a flow performance perspective. A 0.020 inch difference in apex radius or equivalent radius causes approximately a 2-3 times larger discharge coefficient (C) shift with a rounded apex than with a truncated flat apex. Small differences in truncated flat apex values impact discharge coefficient (C) less than equivalent small differences to rounded apex values. This data indicates that rounded apexes are more sensitive to dimensional variation than truncated flat apexes. In other words, truncated flat apexes are better in a production environment for discharge coefficient predictability and therefore a better choice for a predictable and uncalibrated product in a real-world environment.

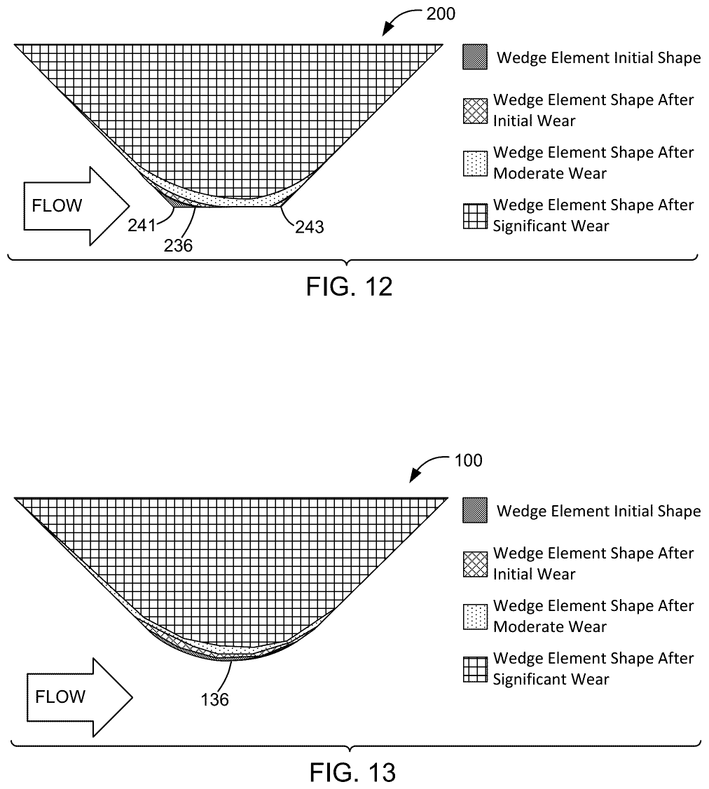

FIG. 12 illustrates an enlarged schematic view of a wear pattern on truncated flat apex 236 of wedge element 201, while FIG. 13 illustrates an enlarged schematic view of wear pattern on rounded apex 136 on wedge element 101. The upstream and downstream apex edges 241 and 243 of truncated flat apex 236, while not rounded, are not “sharp” due to being obtuse. For example, each of edges 241 and 243 of truncated flat apex 236 are at an angle 237 (FIG. 6) of approximately 135 degrees relative to upstream wall 232 and downstream wall 234, respectively, compared to orifice plate square edge of 90 degrees. These obtuse edges wear out slower than a sharper edge. As illustrated in FIGS. 12 and 13, edge wear is also less impactful on truncated flat apex 236 than rounded apex 136. This is confirmed in flow testing. In addition, as truncated flat apex 236 wears out or erodes in difficult applications, truncated flat apex 236 first turns into a rounded apex feature before changing height h (FIG. 12).

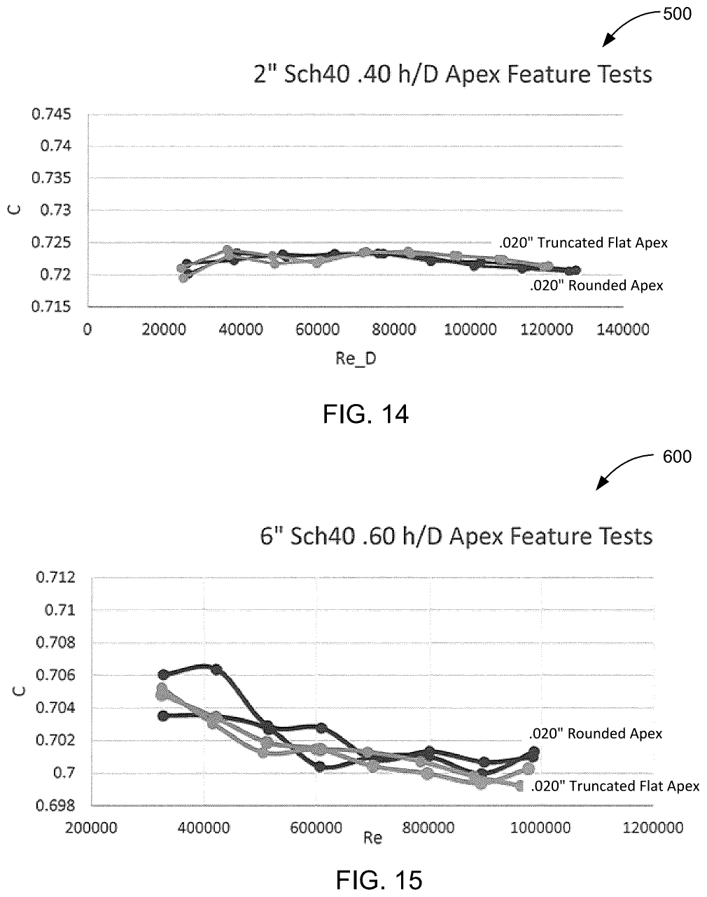

FIG. 14 is a graph 500 illustrating flow test results for a two inch schedule 40 (Sch40) pipe wedge meter that has been flow tested with wedge elements having a rounded apex 136 and equivalent truncated flat apex 236, both having apex radii of 0.020 inch and being at a h/D ratio of 0.40. FIG. 15 is a graph 600 illustrating flow test results for a six inch schedule 40 (Sch40) pipe wedge meter that has been flow tested with wedge elements having a rounded apex 136 and equivalent truncated flat apex 236, both having apex radii of 0.020 inch and being at a h/D ratio of 0.60. For many of the most common h/D ratios (0.40-0.60 h/D) and shown in FIGS. 14 and 15, there is almost no shift in discharge coefficient between a 0.020 inch rounded apex discharge coefficient and an equivalently sized truncated flat apex. This means that when a truncated flat apex 236 wears into a rounded apex, there is no discharge coefficient shift, so the wedge meter maintains its baseline performance through the initial wear.

In contrast, as a rounded apex 136 wears out it becomes rounder and causes the wedge element to lose height (see FIGS. 10 and 11 graphs and FIG. 15). Changes to roundness and wedge element height will cause a shift to the discharge coefficient, albeit this does take considerably longer with wedge meter geometries than with competing flow measurement technologies (such as orifice technologies). As erosion increases to the point of significant wear, more meaningfully altering both the roundness of the radius and the wedge opening height (h), the discharge coefficient will shift more drastically relative to the impacts of initial wear regardless of wedge element apex type.

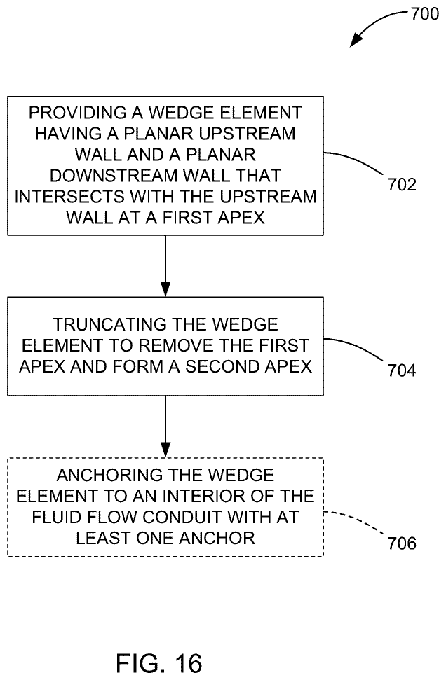

FIG. 16 is an embodiment of a method of fabricating a fluid flow obstruction device. At step 702, a wedge element, such as wedge element 201, is provided having a planar upstream wall, such as upstream wall 232, and a planar downstream wall, such as downstream wall 234 that intersects with the upstream wall at a first apex as illustrated in dashed lines in FIG. 7. At step 704, the wedge element, such as wedge element 201, is truncated to remove the first apex and form a second apex, such as apex 236 having a flat surface as shown in FIG. 7. At step 706, although other options are possible, the wedge element, such as wedge element 201, is anchored to an interior of the fluid flow conduit, such as fluid flow conduit 205 in FIG. 7 with at least one anchor, such as anchor 250 illustrated in FIG. 8.

Although the present invention has been described with reference to preferred embodiments, workers skilled in the art will recognize that changes may be made in form and detail without departing from the spirit and scope of the specification.

What is claimed is:

1. A fluid flow obstruction component for a process fluid flow measurement device, the fluid flow obstruction component being located in a fluid flow conduit and comprising:
an upstream wall having a planar upstream surface; and
a downstream wall having a planar downstream surface that couples to the upstream surface along an apex;
wherein the apex includes a flat surface that extends from an upstream apex edge to a downstream apex edge, the upstream apex edge intersecting with the upstream wall and the downstream apex edge intersecting with the downstream wall.

2. The fluid flow obstruction device of claim 1, where the flat surface of the apex is oriented at a first obtuse angle relative to the upstream surface of the upstream wall and the flat surface of the apex is oriented at a second obtuse angle relative to the downstream surface of the downstream wall.

3. The fluid flow obstruction device of claim 2, wherein the first obtuse angle and the second obtuse angle are the same.

4. The fluid flow obstruction device of claim 1, wherein the downstream surface is oriented at a perpendicular angle relative to the upstream surface.

5. The fluid flow obstruction device of claim 1, further comprising a rounded outside wall having a radius of curvature that corresponds with an inner radius of curvature of the conduit and intersects with the upstream wall, the downstream wall and the apex.

6. The fluid flow obstruction device of claim 5, wherein the rounded outside wall of the fluid flow obstruction component is secured to an interior of the fluid flow conduit with at least one anchor.

7. The fluid flow obstruction device of claim 6, wherein the apex is spaced apart from an inner surface of the fluid flow conduit by a throat opening height (h).

8. The fluid flow obstruction device of claim 7, wherein the ratio of the throat opening height to an inner diameter of the conduit (h/D) is in a range between 0.20 and 0.60.

9. A method of fabricating a fluid flow obstruction component located in a fluid flow conduit for a process fluid flow measurement device comprising:
providing a wedge element having a planar upstream wall and a planar downstream wall that intersects with the upstream wall at first apex; and
truncating the wedge element to remove the first apex and form a second apex, wherein the second apex includes a flat surface that extends from an upstream apex edge to a downstream apex edge, the upstream apex edge intersecting with the upstream wall and the downstream apex edge intersecting with the downstream wall.

10. The method of claim 9, wherein the flat surface of the second apex is oriented at a first obtuse angle relative to an upstream surface of the upstream wall and is oriented at a second obtuse angle relative to a downstream surface of the downstream wall.

11. The method of claim 10, wherein the first obtuse angle and the second obtuse angle are the same.

12. The method of claim 9, wherein the downstream wall is oriented at a perpendicular angle relative to the upstream wall.

13. The method of claim 10, further comprising anchoring the wedge element to an interior of the fluid flow conduit with at least one anchor.

14. A system for measuring process fluid flow, the system comprising:
a fluid flow conduit having an inlet and an outlet;
a fluid flow obstruction component comprising:
an upstream wall having a planar upstream surface; and
a downstream wall having a planar downstream surface that couples to the upstream surface at an apex;
wherein the apex includes a flat surface that extends from an upstream apex edge to a downstream apex edge, the upstream apex edge intersecting with the upstream surface and the downstream apex edge intersecting with the downstream surface; and
a differential pressure sensor disposed to sense differential process fluid pressure on either side of the fluid flow obstruction component.

15. The system of claim 14, where the flat surface of the apex is oriented at a first obtuse angle relative to the upstream surface of the upstream wall and the flat surface of the apex is oriented at a second obtuse angle relative to the downstream surface of the downstream wall.

16. The system of claim 15, wherein the first obtuse angle and the second obtuse angle are the same.

17. The system of claim 14, wherein the downstream surface is oriented at a perpendicular angle relative to the upstream surface.

18. The system of claim 14, wherein the fluid flow obstruction component further comprises a rounded outside wall having a radius of curvature that corresponds with an inner radius of curvature of the fluid flow conduit and intersects with the upstream wall, the downstream wall and the apex.

19. The system of claim 18, wherein the rounded outside wall of the fluid flow obstruction component is secured to an interior of the fluid flow conduit with at least one anchor.

20. The fluid flow obstruction device of claim 6, wherein the apex is spaced apart from an inner surface of the fluid flow conduit by a throat opening height (h), the ratio of the throat opening height to an inner diameter of the conduit (h/D) being in a range between 0.20 and 0.60.
